(19) United States
(12) Patent Application Publication
(10) Pub. No.: US 2003/0152153 A1
(43) Pub. Date: Aug. 14, 2003

(54) Signaling through electromagnetic couplers

(76) Inventors: Thomas D. Simon, Marlborough, MA (US); Rajeevan Amirtharajah, Providence, RI (US); John R. Benham, Westborough, MA (US)

Correspondence Address: FISH & RICHARDSON, PC, 4350 LA JOLLA VILLAGE DRIVE, SUITE 500, SAN DIEGO, CA, 92122, US

(21) Appl. No.: 10/077,684

(22) Filed: Feb. 14, 2002

(51) Int. Cl. H04B 3/00

(52) U.S. Cl. 375/257

(57) ABSTRACT

A probe is positioned in the vicinity of a conductor. By electromagnetic coupling, a coupled signal is derived from a signal carried on the conductor. Based on the coupled signal, an evaluation is performed of the signal, the conductor, or a circuit associated with the signal or the conductor.

### BACKGROUND

This invention relates to signaling through electromagnetic couplers.

Electromagnetic couplers can be used, for example, to couple data between an electronic device and a communication bus in place of more conventional direct electrical connections (see U.S. Pat. No. 5,638,402).

An electronic device that communicates data on a bus sends or receives the data in the form of an electrical signal that conforms to a predefined signaling specification. In recovering the data from the received signal, the receiving device typically assumes that the signal conformed to the specification when it was sent.

### DESCRIPTION

Each of the following figures illustrates elements and features of only some implementations. Other implementations are also within the scope of the claims.

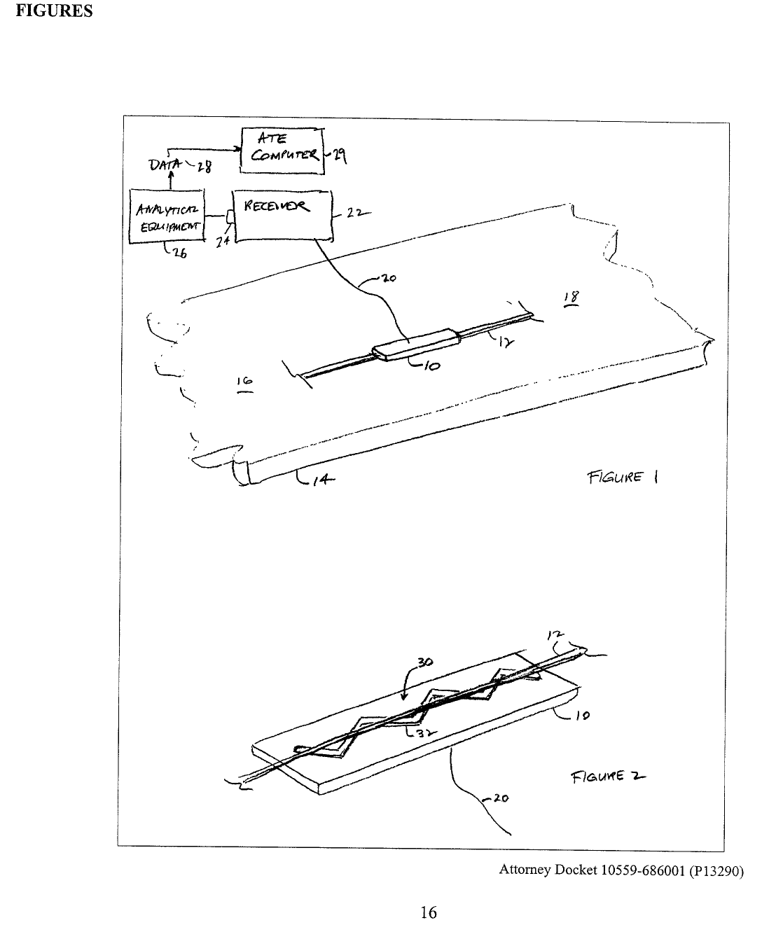

FIG. 1 is a three-dimensional view of a portion of an electromagnetic coupling system.

FIG. 2 is a three-dimensional view of the bottom of a coupling probe.

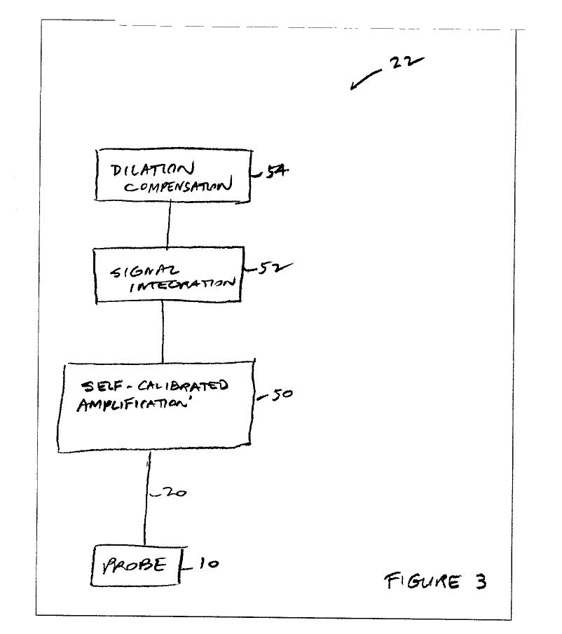

FIG. 3 is a block diagram of signal processing circuitry.

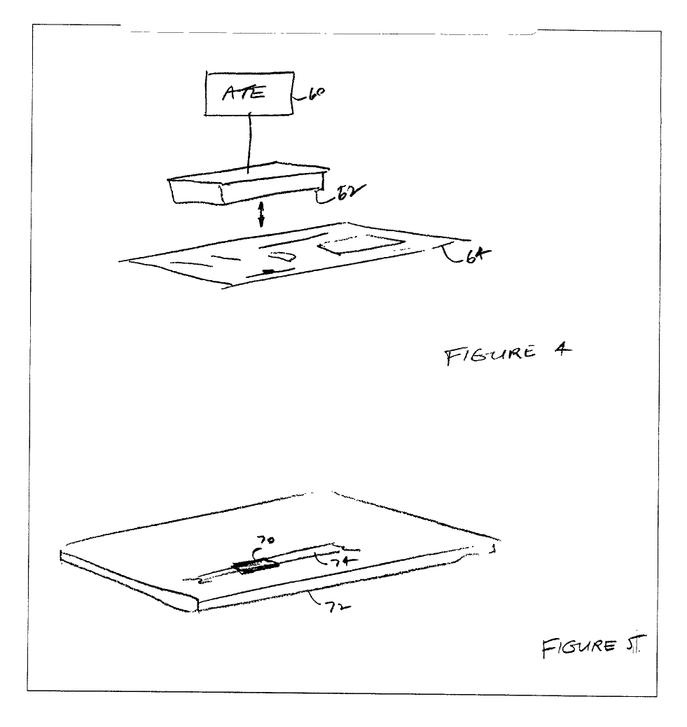

FIG. 4 is a schematic diagram of an automated testing system.

FIG. 5 is a three-dimensional schematic view of a circuit.

As shown in FIG. 1, in some implementations, a probe 10 that includes an electromagnetic coupler (shown in FIG. 2) may be used to probe signals carried on a conductor 12 without requiring a direct mechanical or electrical connection to the conductor. The signals carried on the conductor may be analog or digital signals. The conductor may be part of a digital circuit 14, for example, the conductor may be a wire or conductive trace that is part of a circuit built from discrete components or a conductive feature that is part of a surface of an integrated circuit chip. The conductor may be part of a multi-conductor bus or of a non-bus conductor that connects two points 16, 18 of the circuit.

The probe 10 may be connected by a communication link 20 (e.g., a wire or cable or wirelessly) to a receiver 22. The receiver may include circuitry that processes the probed analog signal to determine its characteristics and provides information about the characteristics on an output port 24 for use by analytical equipment 26 that may be located nearby or remotely. The characteristics may be any arbitrary signal characteristics, such as the level of the signal, the locations of signal edges, or the duration of portions of the signal, for example. In some cases, the signal characteristics need not be analyzed in a receiver or analytical equipment. Rather, an actual waveform of the signal may simply be displayed to a user for a variety of purposes.

The analytical equipment may derive the underlying data 28 based on the signal characteristics or may perform other analyses of the characteristics for a variety of purposes.

The receiver may be part of the probe or may be located a short distance from the probe. The circuitry of the receiver may be split so that some of it is located with the probe and the rest is located at the other end of link 20.

The analytical equipment and the receiver may be part of the same device or split in various ways. The analytical equipment, the receiver, and the probe may all be part of a single device.

Additional couplers (not shown) may be connected to a receiver 22 and used to probe other conductors (not shown) at the same time that conductor 12 is being probed.

The analytical equipment may, among other things, derive the data embedded in the signal that is carried on the conductor 12 and detected through the probe 10. However, in typical implementations, the analytical equipment does not derive the data for the purpose of receiving and using the information that the data represents. Rather the derived data may be used for other purposes such as testing or debugging of a circuit. The analytical equipment may output the digital data 28 for use in other equipment not shown. The other equipment may include computers 29 of the kind used to analyze the outputs of typical automated test equipment.

For example, the derived data may be used in the testing of a circuit without requiring “real estate” to be dedicated in the usual way to test pads at which direct probe connections would be made.

As shown in FIG. 2, on the bottom side 30 of probe 10 there may be a zigzag coupler 32. When the probe is in use, the coupler 32 may be placed adjacent to the conductor 12. The coupler 32 electromagnetically couples to (but is not electrically connected directly to) the conductor 12. The coupler need not have a zigzag contour but could be straight or have other configurations. The conductor 12 need not be straight. Additional information concerning such couplers may be found, for example, in U.S. patent application Ser. No. 09/714,899, filed Nov. 15, 2000.

The proximity and orientation of the coupler to the conductor, and strength and other characteristics of the resulting coupling, may, in many cases, be somewhat unpredictable. The receiver may be configured not to make any assumption about the characteristics of the coupling but rather to self-calibrate to accommodate the actual coupling characteristics that exist at a given time.

In some implementations, a device, not shown, such as a thin piece of plastic or a solder mask coating that exists on a printed circuit board could be used to provide a predetermined small gap between the coupler and the conductor so that the degree of coupling will be somewhat predictable and consistent.

A variety of techniques may be used to place the electromagnetic coupler in an appropriate position adjacent to the conductor. In some cases, the probe may be manipulated by hand. In some other implementations, for example the one shown in FIG. 4, the probe may be connected to a probe head 60 that is controlled by automated equipment (such as automated test equipment 62) that would automatically position the probe on a succession of conductor-bearing circuits 64 being probed.

The receiver and the analytical equipment may be designed and configured for particular applications. In some cases, when the characteristics of the signals carried on the conductor (and of the data carried on the signals) are known or suspected in advance, the circuitry and software included in the receiver and analytical equipment may be designed to analyze the expected signals and data. In other cases, when the characteristics of the signals and data may not be known in advance, the circuitry and software of the receiver and the analytical equipment may have broader, more general capabilities to infer those characteristics.

The probe, receiver, and analytical equipment provide a system that may be non-invasive. The system may therefore easy to use and adaptable to circuits and conductors that have not been (and sometimes could not have been) designed in advance to permit direct electrical connection for probing purposes. On the other hand, it may be possible to design the conductors and circuits being probed so that the use of the electromagnetic coupler probe becomes especially easy and efficient.

Among other advantages, signals having small energies may be transferred from the conductor to the coupler with little impact on impedances. Thus, circuits may be observed as they run essentially undisturbed in their normal operating environments. Such faithful, at speed testing is especially important for probing high-speed tight tolerance, mixed-signal circuits.

The probing is also mechanically non-invasive. As long as the signal of interest traverses a modest distance (for example, a distance less than 1 cm, perhaps only a couple of mm) on a surface layer or conductor, the probe can be placed against the conductor for measurement and removed again afterward. The ability to test without needing elaborate fixtures, soldering, or other rework reduces cost and makes field-testing easy.

The alignment tolerance of the zigzag coupler shown in FIG. 2 aids in establishing reliable test connections. This is useful in cases where the probe is not aligned to the conductor using a mechanical fixture designed into or attached to the circuit being probed, and when the probe is positioned by hand.

The mismatch in effective length (or equivalently speed of propagation) between a straight signal and a zigzag probe may result in a time dilation of the sensed signal. This can be compensated by signal processing after or in the receiver 22.

For very closely spaced signal conductors, such as neighbors in a bus, there may not be enough lateral space to fit a zigzag above one of the conductors without overlapping other adjacent conductors, making it difficult to isolate the desired conductor. In that case, the coupler trace could be a straight line, of the same or smaller line width as the tested trace. (In other cases, when there is plenty of room, the coupler trace could be wider than the tested trace.) When both the conductor and the coupler are straight lines, it may be hard to use manual placement to achieve alignment good enough for adequate coupling. Even in that case, a visual registration aid could be provided, for example, a marker on the probe lined up with the center of the probe trace which would then be lined up with the conductor. Processing in or after the receiver could be used to compensate for a wide range of sensed signal strength.

Another advantage of an electromagnetically coupled probe is the isolation of the DC voltages of the probe and the signal carried on the conductor. This isolation may enable the probe to be more precisely biased and may enable a wider range of signal voltages to be sensed. AC coupling is sometimes purposely introduced in test setups using extra components; the system described here does not require extra components.

The receiver 22 includes self-calibrated amplification circuitry 50 to amplify the coupled signal from the probe 10 to compensate for coupler attenuation and its uncertainties. If the probed signals are known to be standard digital signals, and the information being recovered is mostly edge timing, the amplification function can be performed using, for example, signaling circuitry of the kind described in U.S. patent application Ser. Nos. 09/792,502 and 09/792,546, filed on Nov. 15, 2000.

If the signals being probed are more arbitrary, or are analog signals, the amplification is performed more carefully. First, the calibration of the amplifier gain may have to be performed without knowing the originating test signal amplitude. Therefore it may not be enough to calibrate the receiver gain from just one coupled amplitude (e.g., the backward cross talk component). Instead, amplitude and phase information from both forward and backward coupled waves may be used to derive the coupling strength, even from an unknown amplitude source. Once this coupling strength is known, the amplification would need to be linear and of some minimum precision to faithfully reproduce an arbitrary waveform. This is in contrast to receiver circuitry that reproduces edge timing by triggering a latch when a receiver threshold is passed (which is both a nonlinear and low precision recovery technique).

The coupler 10 may have a tendency to differentiate the waveform carried on the conductor. To compensate for the differentiation, the receiver may include integration circuitry 52 that, for analog waveform recovery, performs linear and accurate integration.

The receiver may also include compensation circuitry 54 that compensates for a time dilation of the coupled signal produced by a zigzag coupler trace relative to a straight conductor trace or, for example, mismatched speeds of propagation in differing materials.

While any of the above functionality may be met using carefully designed, individual, cross-optimized, integrated circuit components, some implementations could replace any or all of those elements with a fast analog-to-digital (A/D) converter with digital signal processing (DSP) software controlled post processing of the captured samples. This arrangement could integrate the probes with a digital sampling oscilloscope.

Especially with the above arrangement, reusing most of the hardware of automated test equipment front-end analog circuitry and digital post processing, while adding electromagnetic coupling at the probe and specialized calibration and recovery DSP software, this solution compares favorably, from a cost standpoint, with alternative non-intrusive test methods such as electron beam or optical probing.

Although some implementations have been described and shown above, other implementations are also within the scope of the following claims.

As shown in the example of FIG. 5, in some implementations all or part of the probe 70 may be fabricated or integrated with the circuit 72 or trace 74 to be tested. A mechanical element may be included on a circuit board to provide an indexing location for positioning the probe relative to a trace. Or the probe could be designed to index relative to a particular comer or edge of the board.

1. A method comprising
positioning a probe in the vicinity of a conductor,
by electromagnetic coupling, deriving a coupled signal from a signal carried on the conductor, and
based on the coupled signal, performing an evaluation of the signal, the conductor, or a circuit associated with the signal or the conductor.

2. The method of claim 1 in which the evaluation comprises testing of a circuit associated with the conductor.

3. The method of claim 1 in which the probe is positioned manually in the vicinity of the conductor.

4. The method of claim 1 in which the probe is positioned automatically in the vicinity of the conductor.

5. The method of claim 1 in which the evaluation of the signal includes amplifying the signal to account for variations in the strength of the coupling.

6. The method of claim 1 in which the evaluation of the signal includes integrating the signal to account for differentiation effects associated with the coupling.

7. The method of claim 1 in which the evaluation of the signal includes dilation compensation to account for dilation of the time scale of the signal.

8. The method of claim 1 in which the probe is positioned only temporarily in the vicinity of the conductor.

9. A method comprising
automatically positioning a probe in the vicinity of a conductor of a circuit under test,
electromagnetically coupling signals from the conductor to the probe, and
automatically testing the circuit by evaluating the coupled signals compared to reference signals.

10. The method of claim 9 in which the testing comprises testing of a circuit associated with the conductor.

11. The method of claim 9 in which the testing of the signal includes amplifying the signal to account for variations in the strength of the coupling.

12. The method of claim 9 in which the testing of the signal includes integrating the signal to account for differentiation effects associated with the coupling.

13. The method of claim 9 in which the evaluation of the signal includes dilation compensation to account for dilation of the time scale of the signal.

14. The method of claim 9 in which the probe is positioned only temporarily in the vicinity of the conductor.

15. Apparatus comprising
a probe having a coupler configured for electromagnetic coupling, from a conductor to the probe, of a signal that is carried on the conductor, and
circuitry connected to the probe and configured to perform an evaluation of the signal, the conductor, or a circuit associated with the signal or the conductor using the coupled signal.

16. The apparatus of claim 15 in which the coupler comprises a conductive trace.

17. The apparatus of claim 16 in which the conductive trace comprises a zigzag trace.

18. The apparatus of claim 15 in which the circuitry includes amplification circuitry.

19. The apparatus of claim 15 in which the circuitry includes integration circuitry.

20. The apparatus of claim 15 in which the circuitry includes dilation compensation circuitry.

21. The apparatus of claim 15 also including a communication link between the probe and the circuitry.

22. The apparatus of claim 15 also including analytical equipment connected to receive evaluation information from the circuitry.

23. The apparatus of claim 15 also including an automatic test equipment computer.

24. A system comprising
a probe having a coupler configured for electromagnetic coupling, from a conductor to the probe, of a signal that is carried on the conductor,
structure configured to automatically position the probe for electromagnetic coupling to the conductor and
automatic testing equipment including circuitry connected to the probe and configured to perform an evaluation of the signal, the conductor, or a circuit associated with the signal or the conductor using the coupled signal.

25. The apparatus of claim 24 in which the coupler comprises a conductive trace.

26. The apparatus of claim 25 in which the conductive trace comprises a zigzag trace.
